(19) United States
(12) Patent Application Publication
(10) Pub. No.: US 2026/0168965 A1
(43) Pub. Date: Jun. 18, 2026

(54) METHOD AND ASSEMBLY FOR ULTRASONIC TESTING OF AN INDUSTRIAL PART

(71) Applicant: AUBERT & DUVAL, Issy-les-Moulineaux (FR)

(72) Inventors: Julien BANCHET, Issy-les-Moulineaux (FR); Frédéric BOBOT, Issy-les-Moulineaux (FR); William MATHIEU, Issy-les-Moulineaux (FR); Benjamin PICQUE, Issy-les-Moulineaux (FR)

(21) Appl. No.: 19/422,053

(22) Filed: Dec. 16, 2025

(30) Foreign Application Priority Data
Dec. 17, 2024 (FR) 24 14380

(51) Int. Cl. G01N 29/06

(52) U.S. Cl. CPC G01N 29/0645; G01N 2291/0234; G01N 2291/0289; G01N 2291/101

(57) ABSTRACT

The method comprises:
a step (S10) of generating a reference framework providing for a plurality of ultrasonic testing operations defined by testing parameters;
a step (S20) of establishing an ultrasonic testing program defining for each ultrasonic testing operation operational parameters;
a step (S30) of ultrasonic testing of the industrial part (10), with recording of data characterizing the ultrasonic testing processes actually implemented;
a step (S40) of verifying the conformity of the ultrasonic testing with:
   a sub-step (S41) of verifying the conformity of the ultrasonic testing program with respect to the reference framework, using the testing parameters and the operational parameters;
   a sub-step (S42) of verifying the conformity of the ultrasonic testing with respect to the reference framework, using the testing parameters and the actual parameters.

The present invention generally relates to a method for ultrasonic testing of an industrial part.

Industrial parts can be tested by ultrasound to ensure they do not include internal defects.

These parts sometimes have complex shapes.

The testing method typically comprises a step of establishing an ultrasonic testing plan for the industrial part, and a step of ultrasonic testing of the industrial part according to the previously established testing plan.

The ultrasonic testing step is carried out with the utmost care, but errors in applying the testing plan can occur.

In this context, the invention aims to propose an ultrasonic testing method that ensures better reliability for the testing of industrial parts.

To this end, the invention according to a first aspect relates to an ultrasonic testing method for an industrial part, the method comprising:
a step of generating a reference framework providing for a plurality of ultrasonic testing operations of the industrial part, the reference framework defining for each ultrasonic testing operation a set of testing parameters;
a step of establishing an ultrasonic testing program for the industrial part defining for each ultrasonic testing operation a set of operational parameters;
a step of ultrasonic testing of the industrial part according to said ultrasonic testing program, with recording of data characterizing the ultrasonic tests actually implemented for each ultrasonic testing operation;
a step of verifying the conformity of the ultrasonic testing of the industrial part with:
a sub-step of verifying the conformity of the ultrasonic testing program with respect to the reference framework, comprising, for each ultrasonic testing operation of the ultrasonic testing program, a verification that a plurality of criteria are met using the testing parameters and the operational parameters;
a sub-step of verifying the conformity of the ultrasonic testing with respect to the reference framework, comprising, for each ultrasonic testing operation, an extraction of effective parameters from the recorded data, and a verification that a plurality of criteria are met using the testing parameters and the effective parameters.

The reference framework gathers the requirements to be met. These requirements come from the specifications set by the client. These requirements are transcribed into numerical or descriptive criteria, taking into account the feedback for the ultrasonic testing of similar industrial parts.

The verification step allows validation of the testing method at two levels.

It first allows validation that the ultrasonic testing program is compliant with the reference framework. It then allows validation that, during the implementation of this program, the ultrasonic testing operations were carried out in accordance with the reference framework.

This double check improves the reliability of the ultrasonic testing method.

The testing method may further comprise one or more of the following features, considered individually or in any technically possible combination:
the sub-step of verifying the conformity of each ultrasonic testing operation of the ultrasonic testing program and/or the sub-step of verifying the conformity of the testing is performed automatically by a computing unit and generates at least one file listing the criteria that are not met and deviations from said criteria;
the verification step comprises a sub-step of analyzing the at least one file by a specialist, the specialist analyzing the deviations from said criteria to be met and deciding based on the deviations whether the ultrasonic testing is accepted or not;
at least one of the criteria to be verified in the sub-step of verifying the conformity of the ultrasonic testing program is a numerical criterion applied to a numerical quantity, said sub-step comprising a calculation of a first value characterizing said numerical quantity using at least one operational parameter, a calculation of a second value characterizing said numerical quantity using at least one testing parameter, and a comparison of the first value and the second value;
the set of operational parameters comprises at least:
the entry surface in the industrial part;
operational parameters related to the depth of testing in the industrial part;
the direction of incidence of the ultrasounds relative to the entry surface;
operational parameters related to the transducer;
operational parameters related to the ultrasound beam generated by the transducer;
operational parameters characterizing the trajectory of the transducer on the entry surface;
   the industrial part is a body of revolution around an axis of revolution, the trajectory of the transducer on the entry surface comprising several revolutions around the axis of revolution, with an initial revolution, a final revolution, and possibly intermediate revolutions regularly distributed between the initial revolution and the final revolution, the operational parameters characterizing the trajectory of the transducer on the entry surface comprising a circumferential offset around the axis of revolution between two ultrasound shots of the same revolution and a spatial offset between two revolutions;
   the criteria examined for the sub-step of verifying the conformity of the ultrasonic testing program with respect to the reference framework cover at least the following numerical quantities:
the tested depth for the initial revolution;
the tested depth for the final revolution;
a resolution at the level of the entry surface of the ultrasounds and possibly a resolution at the level of the exit surface of the ultrasounds;
a circumferential overlap between two neighboring ultrasound shots of the same revolution;
an overlap between the ultrasound shots belonging to two neighboring revolutions;
an evaluation threshold allowing the detection of notable indications;
   the set of testing parameters comprises at least:
an entry surface in the industrial part;
testing parameters related to a depth of testing in the industrial part;
a direction of incidence of the ultrasounds relative to the entry surface;
testing parameters characterizing a trajectory on the entry surface of a transducer generating the ultrasounds;
   at least one of the criteria to be verified in the sub-step of verifying the conformity of the ultrasonic testing is a numerical criterion applied to a numerical quantity, said sub-step comprising a calculation of a first value characterizing said numerical quantity using at least one effective parameter, a calculation of a second value characterizing said numerical quantity using at least one testing parameter, and a comparison of the first value and the second value;
   the criteria examined for the sub-step of verifying the conformity of the testing with respect to the reference framework cover at least the following numerical quantities:
the tested depth;
a resolution at the level of the entry surface of the ultrasounds and possibly a resolution at the level of the exit surface of the ultrasounds;
an evaluation threshold allowing the detection of notable indications;
a gain applied to each testing operation;
   for the following numerical quantities:
the resolution at the level of the entry surface of the ultrasounds and possibly the resolution at the level of the exit surface of the ultrasounds;
the evaluation threshold allowing the detection of notable indications;
   the sub-step of verifying the conformity of the ultrasonic testing with respect to the reference framework comprises:
a verification of an initial value of said numerical quantity;
a verification if the numerical quantity has been modified during the ultrasonic testing operation from its initial value to a new value; and
in case of modification, a verification if the new value is compliant with the reference framework.

According to a second aspect, the invention relates to an ultrasonic testing assembly for an industrial part, the testing assembly comprising:
a reference framework providing for a plurality of ultrasonic testing operations of the industrial part, the reference framework defining for each ultrasonic testing operation a set of testing parameters comprising at least:
an entry surface in the industrial part;
testing parameters related to a depth of testing in the industrial part;
a direction of incidence of the ultrasounds relative to the entry surface;
testing parameters characterizing a trajectory on the entry surface of a transducer generating the ultrasounds;
   an ultrasonic testing program for the industrial part defining for each ultrasonic testing operation a set of operational parameters comprising at least:
the entry surface in the industrial part;
operational parameters related to the depth of testing in the industrial part;
the direction of incidence of the ultrasounds relative to the entry surface;
operational parameters related to the transducer generating the ultrasounds;
operational parameters related to the ultrasound beam generated by the transducer;
operational parameters characterizing the trajectory of the transducer on the entry surface;
   an ultrasonic testing device for the industrial part according to said ultrasonic testing program, configured to record data characterizing the ultrasonic tests actually implemented for each ultrasonic testing operation;
   a computing unit configured to perform a verification of the conformity of the ultrasonic testing of the industrial part, said verification comprising:
a verification of the conformity of the ultrasonic testing program with respect to the reference framework, comprising, for each ultrasonic testing operation of the ultrasonic testing program, a verification that a plurality of criteria are met using the testing parameters and the operational parameters;
a verification of the conformity of the ultrasonic testing with respect to the reference framework, comprising, for each ultrasonic testing operation, an extraction of effective parameters from the recorded data, and a verification that a plurality of criteria are met using the testing parameters and the effective parameters.

The testing assembly may further comprise one or more of the following features, considered individually or in any technically possible combination:
at least one of the criteria to be verified in the context of verifying the conformity of the ultrasonic testing program is a numerical criterion applied to a numerical quantity. This verification comprises calculating a first value characterizing the numerical quantity using at least one operational parameter, calculating a second value characterizing the numerical quantity using at least one testing parameter, and comparing the first value and the second value;
the set of operational parameters comprises at least:
the entry surface in the industrial part;
operational parameters related to the depth of testing in the industrial part;
the direction of incidence of the ultrasounds relative to the entry surface;
operational parameters related to the transducer generating the ultrasounds;
operational parameters related to the ultrasound beam generated by the transducer;
operational parameters characterizing the trajectory of the transducer on the entry surface;
   the industrial part is a body of revolution around an axis of revolution, the ultrasonic testing device of the industrial part being configured so that the trajectory of the transducer on the entry surface comprises several revolutions around the axis of revolution, with an initial revolution, a final revolution, and possibly intermediate revolutions regularly distributed between the initial revolution and the final revolution. The operational parameters characterizing the trajectory of the transducer on the entry surface comprise a circumferential offset around the axis between two ultrasound shots of the same revolution and a spatial offset between two revolutions;
   The verification of the conformity of the ultrasonic testing program with respect to the reference framework covers at least the following numerical quantities:
the tested depth for the initial revolution;
the tested depth for the final revolution;
a resolution at the level of the entry surface of the ultrasounds and possibly a resolution at the level of the exit surface of the ultrasounds;
a circumferential overlap between two neighboring ultrasound shots of the same revolution;
an overlap between the ultrasound shots belonging to two neighboring revolutions;
an evaluation threshold allowing the detection of notable indications;
   the set of testing parameters comprises at least:
an entry surface in the industrial part;
testing parameters related to a depth of testing in the industrial part;
a direction of incidence of the ultrasounds relative to the entry surface;
testing parameters characterizing a trajectory on the entry surface of a transducer generating the ultrasounds;
   at least one of the criteria to be verified in the context of verifying the conformity of the ultrasonic testing is a numerical criterion applied to a numerical quantity. This verification comprises calculating a first value characterizing the numerical quantity using at least one effective parameter, calculating a second value characterizing the numerical quantity using at least one testing parameter, and comparing the first value and the second value.
   the criteria examined for verifying the conformity of the testing with respect to the reference framework cover at least the following numerical quantities:
the tested depth;
a resolution at the level of the entry surface of the ultrasounds and possibly a resolution at the level of the exit surface of the ultrasounds;
an evaluation threshold allowing the detection of notable indications;
a gain applied to each testing operation.

Other features and advantages of the invention will emerge from the detailed description given below, as an indication and in no way limiting, with reference to the appended figures, among which:

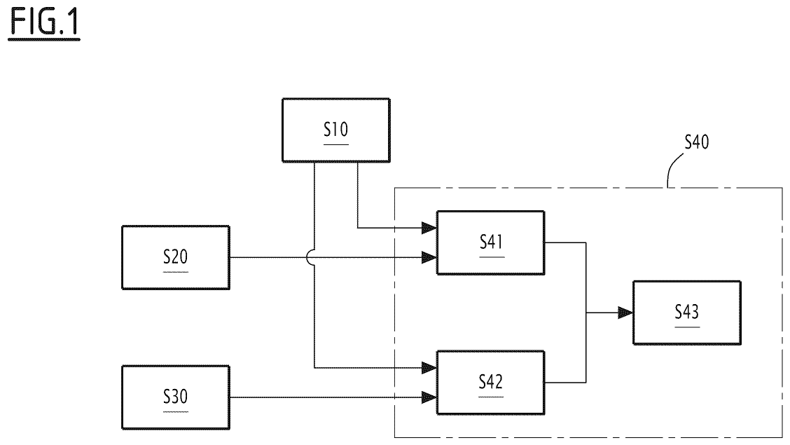

FIG. 1 is a flowchart illustrating the testing method according to the invention;

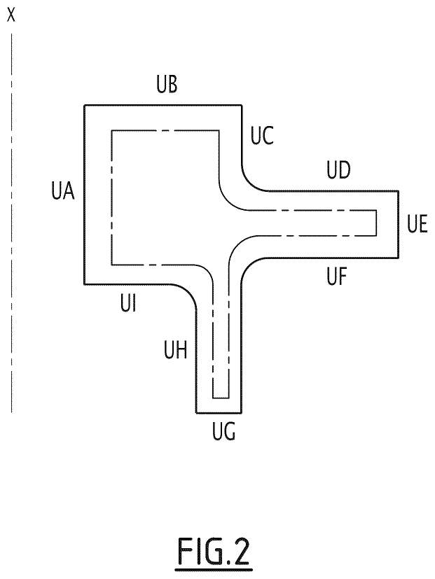

FIG. 2 is an axial sectional view of an industrial part that can be tested using the method according to the invention;

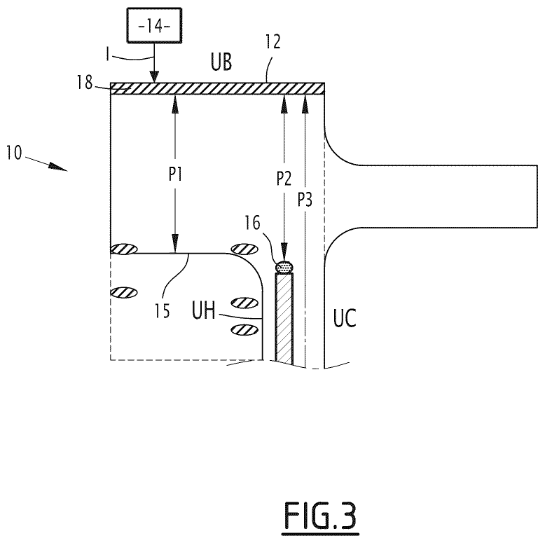

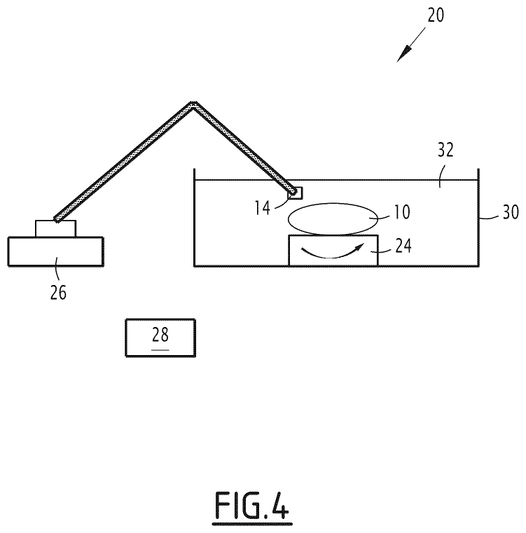

FIG. 3 is a schematic representation of a B-scan superimposed on a part of the section of the industrial part shown in FIG. 4, the B-scan representing the geometry echoes present in the section;

FIG. 4 is a simplified schematic representation of an ultrasonic testing assembly suitable for implementing the method shown in FIG. 1; and

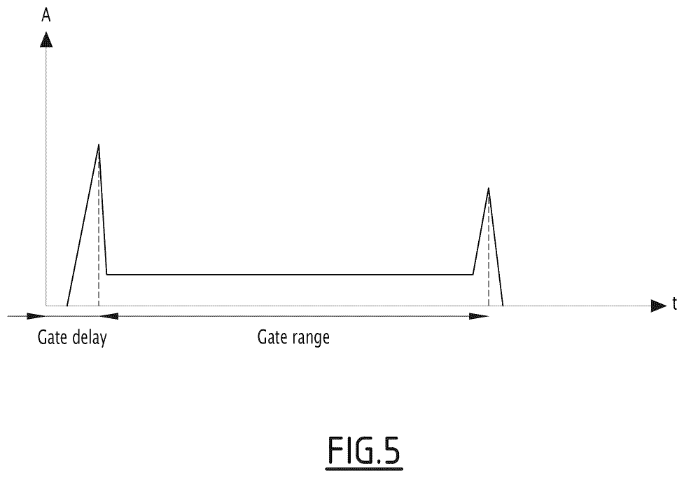

FIG. 5 is a simplified schematic representation of an A-scan, i.e., the amplitude of the ultrasonic signal returned by the part as a function of time during an ultrasonic testing operation.

The method whose steps are shown in FIG. 1 is intended for the ultrasonic testing of an industrial part.

The testing is typically carried out in immersion, the industrial part, during the testing, being immersed in a tank filled with a liquid. This liquid is typically water.

The industrial part is typically a metal part. The part is, for example, made of steel, titanium, or aluminum. Typically, the part is made of an alloy based on Fe, Al, Ti, Ni, or Co. Alternatively, the part is made of a Ni or Co-based superalloy.

Alternatively, the industrial part is a part made of a composite material, for example, a metal matrix composite (MMC).

The industrial part is typically a body of revolution around an axis of revolution X materialized in FIG. 2.

FIG. 2 shows a section of the industrial part 10 to be tested, in a plane containing the axis of revolution X.

The industrial part is typically intended to be mass-produced, i.e., in a large number of copies.

The method is therefore intended to test different series of identical industrial parts.

The part is, for example, intended to be integrated into an aircraft or an aircraft engine. Alternatively, it is intended to be integrated into another type of industrial equipment.

The industrial part 10 subject to the testing method is typically a pre-machined part. It is, for example, obtained by forging a metal ingot.

In this case, it is intended to be machined by the end customer to form the finished part that will be used by this end customer.

In FIG. 2, the finished part is shown in dashed lines inside the industrial part 10 subject to ultrasonic testing.

The ultrasonic testing method comprises:
A step S10 of generating a reference framework providing for a plurality of ultrasonic testing operations of the industrial part 10;
A step S20 of establishing an ultrasonic testing program for the industrial part 10;
A step S30 of ultrasonic testing of the industrial part 10 according to the ultrasonic testing program;
A step S40 of verifying the conformity of the ultrasonic testing of the industrial part 10.

These different steps will now be detailed.

In step S10, the reference framework is generated based on the technical testing criteria to which the industrial part must be subjected.

The reference framework is derived from a testing plan for the part. This testing plan is discussed with the end customer of the part and accepted by this customer.

The reference framework is generated taking into account the geometry of the part, the material constituting it, the feedback concerning this type of geometry and material, and the equipment envisaged for performing the ultrasonic testing processes.

The reference framework gathers all the criteria that must be met for the ultrasonic testing to be validated as conforming to quality requirements.

Compliance with the criteria in the reference framework allows validation that the testing is compliant but does not guarantee in any way that the part is free of defects.

The reference framework is a database.

The reference framework defines, for each ultrasonic testing operation, a set of testing parameters.

The set of testing parameters comprises at least:
An entry surface 12 in the industrial part 10;
Testing parameters related to a depth of testing in the industrial part 10;
A direction of incidence I of the ultrasounds relative to the entry surface 12 (FIG. 3);
Testing parameters characterizing the trajectory on the entry surface 12 of a transducer 14 generating the ultrasounds (FIG. 3).

The entry surface 12 is the surface through which the incident ultrasound beam, emitted by the transducer 14, penetrates the industrial part.

Each entry surface 12 is typically a surface of revolution around the axis of revolution X.

The different entry surfaces 12 used for the ultrasonic testing operations of the part shown in FIG. 2 are referenced UA to UI.

Some entry surfaces are cylindrical and coaxial with the axis of revolution X. This is notably the case for surfaces UA, UC, UE, and UH in the example shown.

Other entry surfaces are rings centered on the axis of revolution X. This is notably the case for surfaces UB, UD, UF, UG, and UI in the example shown.

Still, other surfaces may be conical surfaces coaxial with the axis of revolution X.

These surfaces are connected to each other by rounded or angular junctions.

The trajectory of the transducer 14 on the entry surface 12 comprises several revolutions around the axis of revolution X.

For ring surfaces, the revolutions are, for example, concentric circles. Alternatively, they are coils of a spiral.

For a cylindrical surface, the revolutions are circles axially offset from each other. Alternatively, they are the coils of a helix.

For a conical surface, the revolutions are circles of increasing or decreasing diameters, axially offset from each other. Alternatively, they are the coils of a helix of increasing or decreasing diameters, inscribed in the conical surface.

It should be noted that not all external surfaces of the industrial part 10 are necessarily used as entry surfaces 12 for one of the ultrasonic testing operations. However, the same entry surface 12 can be used multiple times for different testing operations performed under different conditions to provide different information.

The trajectory of the transducer on the entry surface comprises an initial revolution, a final revolution, and possibly intermediate revolutions regularly distributed between the initial revolution and the final revolution.

The testing parameters characterizing the trajectory of the transducer 14 on the entry surface 12 comprise, in particular, the following parameters:
Circumferential offset around the axis of revolution X between two ultrasound shots of the same revolution;
Spatial offset between two revolutions, radially and/or axially.

The testing parameters characterizing the trajectory of the transducer 14 on the entry surface 12 also preferably comprise:
The axial position of the first end of the entry surface 12;
The axial position of the second end of the entry surface 12, opposite the first end of the entry surface.

The direction of incidence I of the ultrasounds relative to the entry surface 12 corresponds to the angle between the normal to the entry surface and the direction of propagation of the incident ultrasound beam emitted by the transducer 14. The direction of incidence is typically perpendicular to the entry surface (incidence angle of 0°). Alternatively, the direction of incidence is inclined relative to the entry surface (incidence angle of 1.6°, 2.4°, 3.6°, 4.8°, etc.).

The depth of testing is the depth of the part that must be tested under the entry surface. This depth typically corresponds to the entire thickness of the part taken between the entry surface 12 and the exit surface 15 (depth P1 in FIG. 3). The exit surface 15 is the area of the external surface of the part reached by the ultrasound beam after having traversed the part over its entire thickness. The ultrasounds are essentially reflected on the exit surface. In some cases, it corresponds to the depth between the entry surface 12 and a geometry echo 16 generated by the reflection of the incident ultrasound beam (depth P2 in FIG. 3). When the part is of great thickness from the entry surface, the depth of testing corresponds to the maximum testable depth given the characteristics of the ultrasound beam (intensity, polarization, frequency, etc.) and the material of the part (depth P3 in FIG. 3).

The testing parameters related to the depth of testing in the industrial part typically comprise the depth of testing for the initial revolution, the depth of testing for the final revolution, and an indication of the evolution of the depth of testing between the initial revolution and the final revolution.

This indication is typically chosen from the following values:
no evolution (the depths of testing are constant for all revolutions);
linear evolution (the depth of testing is incremented regularly between the first revolution and the last revolution);
step evolution, which corresponds to several successive linear evolutions.

The depth of testing is expressed in sound path (length of the path of the ultrasonic waves) or in depth perpendicular to the entry surface. These two depth values are not identical, especially when the incidence angle is not zero.

The testing parameters related to the depth of testing in the industrial part preferably also comprise the incoming resolution and the outgoing resolution. The incoming resolution corresponds to a thickness of the industrial part that cannot be tested under the entry surface 12. The incoming resolution depends in particular on the material of the tested part, the surface condition of the part, and the transducer used.

The non-testable thickness 18 shown in FIG. 3 corresponds to the incoming resolution.

The outgoing resolution corresponds to the thickness that cannot be tested immediately before the exit surface of the ultrasounds. When the tested depth is too great, the transducer does not receive an echo from the exit surface, so the value provided for the outgoing resolution is zero.

The set of testing parameters preferably includes one or more of the following parameters:
frequency of the ultrasounds emitted by the transducer 14, for example, 10 MHz or 20 MHz;
polarization of the incident ultrasound beam (longitudinal wave or transverse wave);
implementation or not of a correction factor, and value of the correction factor (the correction factor is applied when the entry surface is not flat).

The set of testing parameters preferably includes the following parameters:
overlap between two successive ultrasound shots belonging to the same revolution;
overlap between the ultrasound shots belonging to two successive revolutions.

These overlaps are expressed as a percentage of the footprint of each ultrasound shot on the entry surface 12, i.e., the overlap ratio between the shots.

Indeed, along the same revolution, the transducer 14 emits incident ultrasound beams at a determined frequency while moving. The footprints of these beams on the entry surface 12 must overlap so that the entire entry surface 12 is scanned.

The overlap rate is an imposed parameter. It depends on the size of the footprint of the incident ultrasound beam on the entry surface 12, the speed of movement of the transducer 14, and the firing frequency of the transducer 14.

It should be noted that the transducer 14 moves at a constant distance from the entry surface 12.

Similarly, the axial offset between two revolutions is chosen so that there is an overlap between, on the one hand, the footprints formed by the incident ultrasound beam on one revolution, and on the other hand, the footprints formed by the incident ultrasound beam on the next revolution. The overlap depends on the size of the footprint formed by the incident ultrasound beam on the entry surface and the axial spatial offset between the two revolutions.

The set of testing parameters also comprises an evaluation threshold, expressed as a percentage of full scale, below which the echoes are not considered to correspond to a notable indication.

In step S20, an ultrasonic testing program for the industrial part 10 is established. This program defines for each ultrasonic testing operation a set of operational parameters.

The set of operational parameters comprises at least:
the entry surface 12 in the industrial part;
operational parameters related to the depth of testing in the industrial part;
the direction of incidence of the ultrasounds relative to the entry surface 12;
operational parameters related to the transducer 14 generating the ultrasounds;
operational parameters related to the ultrasound beam generated by the transducer 14;
operational parameters characterizing the trajectory of the transducer 14 on the entry surface 12.

The entry surface and the direction of incidence are as defined above.

The operational parameters related to the depth of testing in the industrial part are typically the same as the testing parameters related to the depth of testing in the industrial part.

The operational parameters related to the transducer 14 comprise, for example, one or more of the following parameters:
number of transmitter-receiver elements of the transducer;
geometry of the transducer: spherical surface and radius of curvature of the sphere, circular surface and radius of the circular surface, rectangular surface, etc.;
frequency of the emitted ultrasounds;
water height between the transducer and the entry surface;
firing frequency of the ultrasounds, i.e., the time interval separating two ultrasound shots.

The operational parameters related to the ultrasound beam generated by the transducer 14 comprise, for example, one or more of the following parameters:
type of wave generated by the transducer 14, chosen between longitudinal wave and/or transverse wave;
size of the footprint of the incident ultrasound beam on the entry surface.

The operational parameters characterizing the trajectory of the transducer 14 on the entry surface 12 comprise, for example, all the testing parameters related to the trajectory of the transducer 14 on the entry surface 12 mentioned above.

The operational parameters characterizing the trajectory of the transducer 14 on the entry surface 12 also comprise the speed of movement of the transducer 14 relative to the entry surface 12.

The set of operational parameters also comprises an evaluation threshold. This evaluation threshold is as described above for the set of testing parameters.

During step S30 of ultrasonic testing of the industrial part, data characterizing the ultrasonic testing processes actually implemented for each ultrasonic testing operation are recorded.

The ultrasonic testing step is typically performed in the ultrasonic testing device 20 shown in FIG. 4. This ultrasonic testing device 20 comprises:
the transducer 14 configured to emit ultrasounds and to detect echoes of the ultrasounds returned by the industrial part 10;
a rotating support 24 on which the industrial part 10 is fixed;
a manipulator 26 moving the transducer 14 at a predetermined distance from the industrial part 10;
a computing unit 28 testing the transducer 14, the rotating support 24, and the manipulator 26, the computing unit being programmed to implement the ultrasonic testing plan.

The industrial part 10 is immersed in a tank 30 filled with a liquid medium 32. Typically, the rotating support 24 is also immersed in the liquid medium. This liquid medium is typically water.

The industrial part 10 is fixed on the rotating support 24 so that the axis of revolution X coincides with the axis of rotation of the rotating support 24.

The manipulator 26 is, for example, a manipulator arm.

The manipulator 26 has a number of degrees of freedom suitable to, in combination with the rotation of the rotating support 24, move the transducer 14 on the entry surface 12 according to the trajectory planned for each ultrasonic testing operation.

The manipulator 26 maintains the transducer 14 at the predetermined distance from the entry surface 12 provided in the ultrasonic testing plan.

The recorded data are the echoes returned by the industrial part 10 and the operating parameters of the testing device 20.

The echoes returned by the industrial part 10 are measured by the transducer 14 and recorded by the computing unit 28. The operating parameters of the testing device 20 are recorded by the computing unit 28.

The operating parameters of the testing device 20 correspond to all the operating parameters of the transducer 14, the manipulator 26, and the rotating support 14.

If the industrial part is not a body of revolution, another ultrasonic testing device can be used, for example, without a rotating platform.

Alternatively, the industrial part is not immersed in a liquid bath. The testing can be performed with the part in the air.

Step S40 of verifying the conformity of the ultrasonic testing of the industrial part comprises:
A sub-step S41 of verifying the conformity of the ultrasonic testing program with respect to the reference framework; and
A sub-step S42 of verifying the conformity of the ultrasonic testing with respect to the reference framework.

Sub-step S41 of verifying the conformity of the ultrasonic testing program with respect to the reference framework comprises, for each ultrasonic testing operation of the ultrasonic testing program, a verification that a plurality of criteria are met, using the testing parameters and the operational parameters.

Sub-step S42 of verifying the conformity of the ultrasonic testing with respect to the reference framework comprises, for each ultrasonic testing operation, an extraction of effective parameters from the recorded data, and a verification that a plurality of criteria are met, using the testing parameters and the effective parameters.

The extraction of effective parameters is performed automatically.

Sub-step S41 of verifying the conformity of each ultrasonic testing operation of the ultrasonic testing program and/or sub-step S42 of verifying the conformity of the testing are performed automatically by a computing unit and generate at least one file listing the criteria that are not met and the deviations from the criteria.

Typically, sub-step S41 and sub-step S42 are performed automatically by the computing unit. The list of criteria that are not met and the corresponding deviations are gathered in the same file.

Furthermore, the verification step S40 comprises a sub-step S43 of analyzing the at least one file by a specialist.

The specialist analyzes the deviations from the criteria to be met and decides based on the deviations whether the ultrasonic testing is accepted or not.

Typically, there is a master testing program that is copied before execution. The program is recorded during its execution, and the recorded program (all criteria) is verified against the reference framework.

Preferably, at least one of the criteria to be verified in sub-step S41 of verifying the conformity of the ultrasonic testing program is a numerical criterion applied to a numerical quantity.

Sub-step S41 then comprises calculating a first value characterizing the numerical quantity using at least one operational parameter, calculating a second value characterizing the numerical quantity using at least one testing parameter, and comparing the first value and the second value.

The numerical criterion to be verified is, for example, that the deviation between the first value and the second value is less than a predetermined maximum. This criterion is predetermined.

The numerical quantities are, for example, the following:
the tested depth for the initial revolution;
the tested depth for the final revolution;
the resolution at the level of the entry surface of the ultrasounds and possibly the resolution at the level of the exit surface of the ultrasounds;
the circumferential overlap between two neighboring ultrasound shots of the same revolution;
the overlap between the ultrasound shots belonging to two neighboring revolutions;
the evaluation threshold allowing the detection of notable indications.

The second value is, for example, read directly from the reference framework or is calculated using the testing parameters in the reference framework.

The first value is read directly from the ultrasonic testing program for the corresponding testing operation or is calculated using the operational parameters in the testing program.

For example, for the circumferential overlap between two neighboring ultrasound shots of the same revolution, the second value is read directly from the reference framework. The first value is calculated using the following operational parameters:
Firing frequency of the transducer;
Circumferential movement speed of the entry surface under the transducer;
Size of the footprint of the ultrasound beam at the level of the entry surface.

The numerical quantity can also be the correction factor.

Sub-step S41 then includes a double test:
first, if the reference framework does not provide for the use of a correction factor for the testing operation, verifying that the ultrasonic testing program does not provide for a correction factor for the operation (correction factor box not checked);
if the reference framework provides for the use of a correction factor for the testing operation, a numerical comparison between the correction factor of the reference framework and that of the testing program. The values of the correction factors are read directly from the reference framework and the testing program.

Similarly, at least one of the criteria to be verified in sub-step S42 of verifying the conformity of the ultrasonic testing is a numerical criterion applied to a numerical quantity. This sub-step then comprises calculating a first value characterizing the numerical quantity using at least one effective parameter, calculating a second value characterizing the numerical quantity using at least one testing parameter, and comparing the first value and the second value.

The numerical criterion to be verified is, for example, that the deviation between the first value and the second value is less than a predetermined maximum, appearing in the reference framework.

The numerical quantities are, for example, the following:
the tested depth for each revolution;
the resolution at the level of the entry surface 12 of the ultrasounds and possibly the resolution at the level of the exit surface 15 of the ultrasounds;
the evaluation threshold allowing the detection of notable indications;
the gain applied to each testing operation.

The first value corresponds directly to the effective parameter extracted from the recorded data or is calculated from one or more effective parameters. For example, for the entry and exit resolution, the evaluation threshold, and the gain, the first value corresponds directly to an effective parameter extracted from the data.

The first value for the tested depth is calculated using the following effective parameters: Gate delay and Gate range.

These parameters are illustrated in FIG. 5, which represents the amplitude of the signal recorded by the transducer 14 as a function of time. The origin of the time axis corresponds to the emission of the incident ultrasonic signal. The Gate delay parameter corresponds to the time interval between the emission of the incident ultrasonic signal and the reception of the echo from the entry surface. This parameter corresponds to the position of the first peak along the time axis.

The Gate range parameter corresponds to the time gap between the two peaks illustrated in FIG. 5. The second peak corresponds to the moment of recording by the transducer 14 of the echo returned by the exit surface. The first value is calculated as follows:
V1=Gate Delay+Gate Range

The second value is read directly from the reference framework for the corresponding testing operation or is calculated using the testing parameters in the reference framework.

For example, for the entry and exit resolution, the evaluation threshold, and the gain, the second value is read directly from the reference framework.

The second value for the tested depth is calculated as follows:
V2=sound path depth−outgoing resolution in sound path.

The sound path depth and outgoing resolution in sound path are parameters appearing directly in the reference framework.

For example, for the circumferential overlap between two neighboring ultrasound shots of the same revolution, the second value is read directly from the reference framework. The first value is calculated using the following effective parameters:
Firing frequency of the transducer;
Circumferential movement speed of the entry surface under the transducer;
Size of the footprint of the ultrasound beam at the level of the entry surface.

Advantageously, sub-step S42 of verifying the conformity of the testing with respect to the reference framework also comprises a test if certain effective parameters have been modified during the ultrasonic testing step. If an effective parameter has been modified, it is possible that this modification was made by an operator and that it led to the effective parameter being outside the acceptable range defined in the reference framework.

This verification is performed in particular for the following numerical quantities:
The resolution at the level of the entry surface of the ultrasounds and possibly the resolution at the level of the exit surface of the ultrasounds;
The evaluation threshold allowing the detection of notable indications.

For these numerical quantities, the sub-step of verifying the conformity of the ultrasonic testing with respect to the reference framework comprises:
a verification of the initial value of the numerical quantity;
a verification if the numerical quantity has been modified during the ultrasonic testing operation from its initial value to its new value; and
in case of modification, a verification if the new value is compliant with the reference framework.

The verification of the initial value of the numerical quantity and the new value of the numerical quantity is performed as described above.

According to a second aspect, the invention relates to an ultrasonic testing assembly of an industrial part.

The testing assembly is specially adapted to implement the testing method described above. Conversely, the testing method described above is designed to be implemented by the testing assembly, which will now be detailed.

The testing assembly comprises:
a reference framework providing for a plurality of ultrasonic testing operations of the industrial part, the reference framework defining for each ultrasonic testing operation a set of testing parameters;
an ultrasonic testing program for the industrial part 10 defining, for each ultrasonic testing operation, a set of operational parameters;
an ultrasonic testing device 20 of the industrial part according to said ultrasonic testing program, configured to record data characterizing the ultrasonic testing processes actually implemented for each ultrasonic testing operation;
a computing unit 28 configured to perform a verification of the conformity of the ultrasonic testing of the industrial part, said verification comprising:
A verification of the conformity of the ultrasonic testing program with respect to the reference framework, comprising, for each ultrasonic testing operation of the ultrasonic testing program, a verification that a plurality of criteria are met using the testing parameters and the operational parameters;
A verification of the conformity of the ultrasonic testing with respect to the reference framework, comprising for each ultrasonic testing operation, an extraction of effective parameters from the recorded data, and a verification that a plurality of criteria are met using the testing parameters and the effective parameters.

The reference framework is as described above.

The set of testing parameters is as described above.

The ultrasonic testing program of the industrial part is as described above.

The set of operational parameters is as described above.

The ultrasonic testing device 20 of the industrial part is as described above. The recording of data is performed by the computing unit 28 of the ultrasonic testing device.

The computing unit configured to perform the verification of the conformity of the ultrasonic testing of the industrial part is the computing unit 28 of the ultrasonic testing device 20 or is a computing unit distinct from it.

The computing unit 28 is configured to perform a verification of the conformity of the ultrasonic testing of the industrial part according to the method described above.

1. An ultrasonic testing method for an industrial part, the method comprising:
a step of generating a reference framework providing for a plurality of ultrasonic testing operations on the industrial part, the reference framework defining for each ultrasonic testing operation a set of testing parameters;
a step of establishing an ultrasonic testing program for the industrial part defining for each ultrasonic testing operation a set of operational parameters;
a step of ultrasonic testing of the industrial part according to said ultrasonic testing program, with recording of data characterizing the ultrasonic testing processes actually implemented for each ultrasonic testing operation;
a step of verifying the conformity of the ultrasonic testing of the industrial part with:
testing program with respect to the reference framework, comprising, for each ultrasonic testing operation of the ultrasonic testing program, a verification that a plurality of criteria are met using the testing parameters and the operational parameters;
a sub-step of verifying the conformity of the ultrasonic testing with respect to the reference framework, comprising, for each ultrasonic testing operation, an extraction of actual parameters from the recorded data, and a verification that a plurality of criteria are met using the testing parameters and the actual parameters.

2. The testing method according to claim 1, wherein the sub-step of verifying the conformity of each ultrasonic testing operation of the ultrasonic testing program and/or the sub-step of verifying the conformity of the testing is performed automatically by a computing unit and generates at least one file listing the criteria that are not met and deviations from said criteria.

3. The testing method according to claim 2, wherein the verification step comprises a sub-step of analyzing the at least one file by a specialist, the specialist analyzing the deviations from said criteria to be met and deciding based on the deviations whether the ultrasonic testing is accepted or not.

4. The testing method according to claim 1, wherein at least one of the criteria to be verified in sub-step of verifying the conformity of the ultrasonic testing program is a numerical criterion applied to a numerical quantity, said sub-step comprising a calculation of a first value characterizing said numerical quantity using at least one operational parameter, a calculation of a second value characterizing said numerical quantity using at least one testing parameter, and a comparison of the first value and the second value.

5. The testing method according to claim 1, wherein the set of operational parameters comprises at least:
the entry surface in the industrial part;
operational parameters related to the testing depth in the industrial part;
the direction of incidence of the ultrasounds relative to the entry surface;
operational parameters related to the transducer;
operational parameters related to the ultrasound beam generated by the transducer;
operational parameters characterizing the trajectory of the transducer on the entry surface.

6. The testing method according to claim 5, wherein the industrial part is a body of revolution around a revolution axis, the trajectory of the transducer on the entry surface comprising several revolutions around the revolution axis, with an initial revolution, a final revolution, and possibly intermediate revolutions regularly distributed between the initial revolution and the final revolution, the operational parameters characterizing the trajectory of the transducer on the entry surface comprising a circumferential offset around the revolution axis between two ultrasound shots of the same revolution and a spatial offset between two revolutions.

7. The testing method according to claim 6, wherein at least one of the criteria to be verified in sub-step of verifying the conformity of the ultrasonic testing program is a numerical criterion applied to a numerical quantity, said sub-step comprising a calculation of a first value characterizing said numerical quantity using at least one operational parameter, a calculation of a second value characterizing said numerical quantity using at least one testing parameter, and a comparison of the first value and the second value; and
wherein the criteria examined for sub-step of verifying the conformity of the ultrasonic testing program with respect to the reference framework cover at least the following numerical quantities:
the tested depth for the initial revolution;
the tested depth for the final revolution;
a resolution at the level of the entry surface of the ultrasounds;
a circumferential overlap between two neighboring ultrasound shots of the same revolution;

8. The testing method according to claim 1, wherein the set of testing parameters comprises at least:
an entry surface in the industrial part;
testing parameters related to a testing depth in the industrial part;
a direction of incidence of the ultrasounds relative to the entry surface;
testing parameters characterizing a trajectory on the entry surface of a transducer generating the ultrasounds.

9. The testing method according to claim 1, wherein at least one of the criteria to be verified in sub-step of verifying the conformity of the ultrasonic testing is a numerical criterion applied to a numerical quantity, said sub-step comprising a calculation of a first value characterizing said numerical quantity using at least one actual parameter, a calculation of a second value characterizing said numerical quantity using at least one testing parameter, and a comparison of the first value and the second value.

10. The testing method according to claim 9, wherein the criteria examined for sub-step of verifying the conformity of the testing with respect to the reference framework cover at least the following numerical quantities:
the tested depth;
a resolution at the level of the entry surface of the ultrasounds;
an evaluation threshold allowing the detection of notable indications;
a gain applied to each testing operation.

11. The testing method according to claim 10, wherein for the following numerical quantities:
the resolution at the level of the entry surface of the ultrasounds;
the evaluation threshold allowing the detection of notable indications;
the sub-step of verifying the conformity of the ultrasonic testing with respect to the reference framework comprises:
a verification of an initial value of said numerical quantity;
a verification if the numerical quantity has been modified during the ultrasonic testing operation from its initial value to a new value; and
in case of modification, a verification if the new value is compliant with the reference framework.

12. An ultrasonic testing system for an industrial part, the testing system comprising:
a reference framework providing for a plurality of ultrasonic testing operations of the industrial part, the reference framework defining for each ultrasonic testing operation a set of testing parameters comprising at least:
an entry surface in the industrial part;
testing parameters related to a testing depth in the industrial part;
a direction of incidence of the ultrasounds relative to the entry surface;
testing parameters characterizing a trajectory on the entry surface of a transducer generating the ultrasounds;
an ultrasonic testing program for the industrial part defining for each ultrasonic testing operation a set of operational parameters comprising at least:
the entry surface in the industrial part;
operational parameters related to the testing depth in the industrial part;
the direction of incidence of the ultrasounds relative to the entry surface;
operational parameters related to the transducer generating the ultrasounds;
operational parameters related to the ultrasound beam generated by the transducer;
operational parameters characterizing the trajectory of the transducer on the entry surface;
an ultrasonic testing device of the industrial part according to said ultrasonic testing program, configured to record data characterizing the ultrasonic testing processes actually implemented for each ultrasonic testing operation;
a computing unit configured to perform a verification of the conformity of the ultrasonic testing of the industrial part, said verification comprising:
a verification of the conformity of the ultrasonic testing program with respect to the reference framework, comprising, for each ultrasonic testing operation of the ultrasonic testing program, a verification that a plurality of criteria are met using the testing parameters and the operational parameters;
a verification of the conformity of the ultrasonic testing with respect to the reference framework, comprising, for each ultrasonic testing operation, an extraction of actual parameters from the recorded data, and a verification that a plurality of criteria are met using the testing parameters and the actual parameters.

13. The testing system according to claim 12, wherein at least one of the criteria to be verified in the context of the verification of the conformity of the ultrasonic testing program is a numerical criterion applied to a numerical quantity, said verification comprising a calculation of a first value characterizing said numerical quantity using at least one operational parameter, a calculation of a second value characterizing said numerical quantity using at least one testing parameter, and a comparison of the first value and the second value.

14. The testing system according to claim 12, wherein the set of operational parameters comprise at least:
the entry surface in the industrial part;
operational parameters related to the testing depth in the industrial part;
the direction of incidence of the ultrasounds relative to the entry surface;
operational parameters related to the transducer generating the ultrasounds;
operational parameters related to the ultrasound beam generated by the transducer;
operational parameters characterizing the trajectory of the transducer on the entry surface.

15. The testing system according to claim 14, wherein the industrial partis a body of revolution around a revolution axis, the ultrasonic testing device of the industrial part being configured so that the trajectory of the transducer on the entry surface comprises several revolutions around the revolution axis, with an initial revolution, a final revolution, and possibly intermediate revolutions regularly distributed between the initial revolution and the final revolution, the operational parameters characterizing the trajectory of the transducer on the entry surface comprising a circumferential offset around the axis between two ultrasound shots of the same revolution and a spatial offset between two revolutions.

16. The testing system according to claim 15, wherein at least one of the criteria to be verified in the context of the verification of the conformity of the ultrasonic testing program is a numerical criterion applied to a numerical quantity, said verification comprising a calculation of a first value characterizing said numerical quantity using at least one operational parameter, a calculation of a second value characterizing said numerical quantity using at least one testing parameter, and a comparison of the first value and the second value; and
wherein the verification of the conformity of the ultrasonic testing program with respect to the reference framework comprises at least the following numerical quantities:
the tested depth for the initial revolution;
the tested depth for the final revolution;
a resolution at the level of the entry surface of the ultrasounds;
a circumferential overlap between two neighboring ultrasound shots of the same revolution;
an overlap between the ultrasound shots belonging to two neighboring revolutions;
an evaluation threshold allowing the detection of notable indications.

17. The testing system according to claim 12, wherein the set of testing parameters comprises at least:
an entry surface in the industrial part;
testing parameters related to a testing depth in the industrial part;
a direction of incidence of the ultrasounds relative to the entry surface;
testing parameters characterizing a trajectory on the entry surface of a transducer generating the ultrasounds.

18. The testing system according to claim 12, wherein at least one of the criteria to be verified in the context of the verification of the conformity of the ultrasonic testing is a numerical criterion applied to a numerical quantity, said verification comprising a calculation of a first value characterizing said numerical quantity using at least one actual parameter, a calculation of a second value characterizing said numerical quantity using at least one testing parameter, and a comparison of the first value and the second value.

19. The testing system according to claim 18, wherein the criteria examined for the verification of the conformity of the testing with respect to the reference framework cover at least the following numerical quantities:
the tested depth;
a resolution at the level of the entry surface of the ultrasounds;
an evaluation threshold allowing the detection of notable indications;
a gain applied to each testing operation.
